(19) United States
(12) Patent Application Publication
(10) Pub. No.: US 2009/0300170 A1
(43) Pub. Date: Dec. 3, 2009

(54) TEST AND MONITORING DEVICE MANAGEMENT WITH MULTI-FACETED COMMUNICATION CAPABILITY

(76) Inventors: William H. Bhame, Madison, GA (US); James M. O'Brien, Marietta, GA (US)

Correspondence Address: Adorno & Yoss, LLC, 1349 West Peachtree Street, NE, Suite 1500, Atlanta, GA, 30309, US

(21) Appl. No.: 12/185,269

(22) Filed: Aug. 4, 2008

Related U.S. Application Data
(60) Provisional application No. 61/130,128, filed on May 28, 2008.

(51) Int. Cl. G06F 15/173

(52) U.S. Cl. 709/224

(57) ABSTRACT

A routing/hub device and a data management system are provided to managing test and monitoring devices such as portable test and monitoring devices in healthcare. The routing/hub device interfaces through a variety of communication means with one or more peripheral devices collecting data and configuring those devices based on user input or input from the data management system. Collected data is provided to the data management system for actions such as analysis, reporting, and the like. Alerts and messages may also be provided to designated recipients directly or through the data management system based on predefined rules for collected data.

### RELATED APPLICATIONS

This application claims the benefit of U.S. Provisional Application Ser. No. 61/130,128 filed on May 28, 2008, which is hereby claimed under 35 U.S.C. §119(e). The referenced Provisional Application is incorporated herein by reference.

### BACKGROUND

In its current state, the healthcare industry is relatively fractured, inefficient, and under significant pressure from increasing demands for cost-efficiency, increased availability of services, improved services, and the like. Critical resources are often dramatically underutilized resulting in increased cost as well as frustration of both patients and care-providers.

Test and monitoring is an important aspect of preventative and continuous care of patients and people at risk for certain diseases and conditions. Diabetes, high blood pressure, seizures are examples of conditions that may require regular monitoring in order to maintain patients' health. In a hospital or similar controlled environment, test and monitoring devices may be connected to a network and results processed by relatively complicated and large systems. On the other hand, relatively small and user-friendly test and monitoring devices are available in the market today, but those are typically for disconnected use by the patients who have to record the results, in some cases interpret themselves, and report to their healthcare providers. Thus, the use of such test and monitoring devices does not improve efficiency, cost, or quality of healthcare significantly.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to a routing/hub device and system for managing one or more test and monitoring end devices through wired and/or wireless communication. According to a preferred embodiment, the routing/hub device is also capable of providing messages, alerts, and the like to a plurality of communication end devices through wired or wireless networks based on predefined conditions and data received from the test and monitoring end device(s), as well as take other predefined actions. A system according to embodiments further includes a data reporting and analysis repository connected to the routing/hub device through public and/or private networks for storing, analyzing, and performing actions on the data received from the test and monitoring end devices.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a diagram illustrating an example hardware architecture of a system according to embodiments;

FIG. 2 illustrates an example routing/hub device according to some embodiments;

FIG. 3 is a conceptual diagram illustrating an example routing/hub device communicating with data reporting and analysis repository in a medical test and monitoring application according to embodiments;

FIG. 4 illustrates an example software architecture of a routing/hub device according to embodiments;

FIG. 5 illustrates a networked environment where embodiments may be implemented; and

FIG. 6 is a block diagram of an example computing operating environment, where embodiments may be implemented.

### DETAILED DESCRIPTION

As briefly discussed above, a routing/hub device configured to manage one or more test and monitoring end devices may be employed to gather data from those end devices, perform actions based on the gathered data such as providing alerts or messages to communication end devices, and provide the data to a reporting and analysis repository for further actions. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments are described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Furthermore, references are made and preferred embodiments are described in conjunction with a medical test and monitoring application. However, embodiments are not limited to medical applications. A routing/hub device for managing test and monitoring end devices and an associated data reporting and analysis repository may be implemented for any type of test and monitoring application including, but not limited to, industrial applications, security applications, and the like, using the principles described herein.

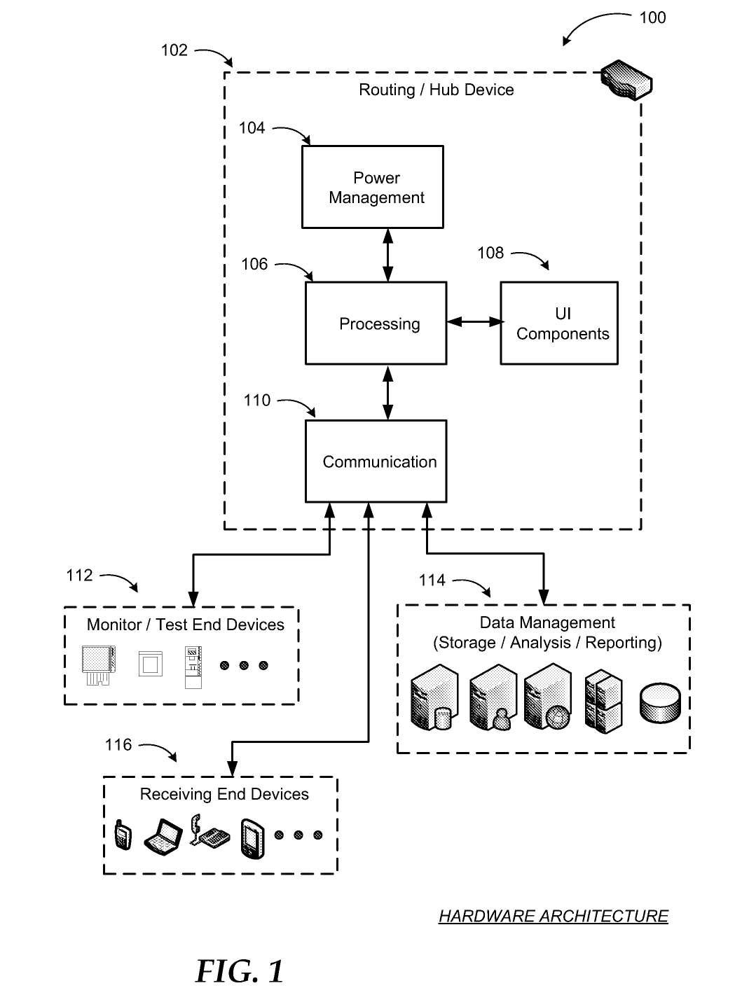

Referring to FIG. 1, diagram 100 of example hardware architecture of a system according to embodiments is illustrated. A crucial component of the test and monitoring device management system is the routing/hub device 102, which includes major operational blocks: power management 104, processing unit 106, user interface components 108, and communication block(s) 110.

Through communication block(s) 110, routing/hub device 102 is capable of communicating with a plurality of devices and systems over a number of communication modes. One of the main capabilities for routing/hub device 102 is management of test and monitoring end devices 112 through some of these communication modes. Since each end device may have a unique (or standardized) communication interface, routing/hub device 102 may be configured to accommodate a variety of physical and programmatic interfaces. These capabilities also include accommodation of various Application Programming Interfaces (APIs) for various end devices. The physical capabilities include different wired and wireless communication interfaces such as Universal Serial Bus (USB), IEEE 1394®, RJ11, RJ45, and the like for wired connections. For wireless connections, a variety of short and long range communication protocols may be employed as well. Examples of such protocols include Wireless LAN (WLAN) protocols, short range low power communication protocols, optical communication protocols, as well as any long range communication systems. Physical and programmatic communication interfaces are well known in the art and not discussed here in exhaustive detail. Embodiments may be implemented using any interface available.

A second capability of the routing/hub device 102 is communication with one or more communication end devices 116. According to a preferred embodiment, routing/hub device 102 is a portable device that manages the test and monitoring end devices, gathers data, and provides the data to data management system 114. The latter system is also responsible for configuring the routing/hub device 102 and providing reports, alerts, etc. to appropriate parties based on the collected data. On the other hand, with ever increasing processing capabilities of microprocessors, portable devices can perform very complex tasks, store large amounts of data, etc. Therefore, routing/hub device 102 does not have to be completely reliant on the data management system 116, and may perform some or all of the tasks associated with gathered data on its own.

For example, routing/hub device 102 may transmit short messages, alerts, and other information to selected communication end devices on its own. The communication end devices may include any device capable of electronic communication such as cellular phones, smart phones, regular phones, computer terminals, and the like. Communication with these may be performed through any wired and wireless means as discussed above, although a long range communication mode such as over a public or private network is more likely to be employed in this communication. Of course, the communication does not have to be limited to short messages or alerts. Any amount of data may be transmitted to a target communication device. The transmission may be configurable through routing/hub device 102, data management system 114, or the target communication device itself.

In one example implementation, data management system 114 may provide default communication configurations, which may be customized by the user of the routing/hub device 102. The user may also give permission to specific recipients for configuring their receipt of messages or data from the routing/hub device 102 such as when and upon what condition a message should be sent to them.

As with any communication over wired or wireless—more importantly, public or private—networks, various security and privacy protocols may be implemented allowing default permission levels to be customized by the user and/or recipients of message/data from the system.

As mentioned above, data management system 114 is typically a more complicated and involved component of the system capable of managing multiple routing/hub devices, collecting data from a variety of test and monitoring devices, analyzing collected data, providing reports based on the analysis, and performing actions based on the analysis and/or preconfigured rules.

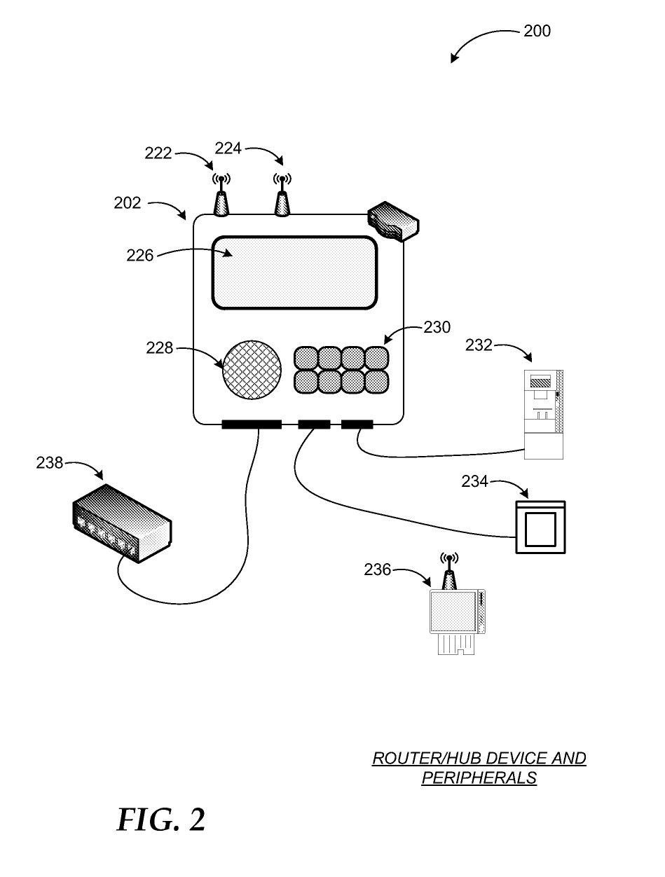

FIG. 2 illustrates an example routing/hub device in diagram 200. As discussed above, routing/hub device 202 may be implemented as a portable device according to a preferred embodiment. According to other embodiments, the functionality of routing/hub device 202 may be implemented in a general purpose computing device such as a smart phone, a Personal Digital Assistant, a handheld computer, or even a stationary computing device. For example, a smart automobile console may be programmed with some of the functionality and provide test and monitoring end device management from the vehicle.

The example portable routing/hub device 202 may include user interface elements such as display 226 and input devices 228, 230. Input devices may be implemented in any way known in the art such as a control wheel 228 or a keypad 230. Of course, other input mechanisms such as a touchpad, an external input device, etc. may also be used.

Communication with various test and monitoring end devices (e.g. 232, 234, 236) may be accomplished through wired connections or wireless connection as shown in the figure. Routing/hub device 202 may correspond with other communication devices as well as a data management system through wired and wireless means as well. Since the communication means for different device types is likely to be different (e.g. short range vs. long range or private vs. public network), two or more different communication interfaces (e.g. antennas 222, 224) may be integrated to the routing/hub device 202.

One example of wired communication is switch 238, which may be connected to routing/hub device through an RJ11 or RJ45 type connection and provide access to Public Switched Telephone Network (PSTN). Thus, if an alert condition is satisfied based on the collected data, routing/hub device 202 may place a call over the PSTN to a designated phone number and provide a voice or data alert. Similarly, communication may be established over cellular networks, wired/wireless data networks (e.g. an enterprise network), or even a unified communications network. Unified communication networks are relatively recent systems combining data, voice, and other communication mechanisms in a user-friendly and efficient manner.

In a unified communication system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a unified communication system, SIP is a preferred method.

The SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real Time Protocol (“RTP”).

SIP is intended to provide a signaling and call setup protocol for IP-based communications that can support a superset of the call processing functions and features present in the PSTN. SIP by itself does not define these features, however. Rather, its focus is call-setup and signaling. SIP is also designed to enable the building of such features in network elements known as proxy servers and user agents. These are features that permit familiar telephone-like operations: dialing a number, causing a phone to ring, hearing ring back tones or a busy signal.

Thus, routing/hub device 202 may operate in conjunction with any test and monitoring device and communication end device configured to work through a standardized communication system. Such devices typically require some form of custom interface. The custom interfacing is accomplished through using an API specific for that device (or a generic one for a device type). Routing/hub device 202 may be configured to include one or more common APIs. Additional APIs may be loaded to the device by the user or by the data management system managing the routing/hub device as needed. Updates to APIs may also be performed automatically or manually as device configurations change or software is further developed.

According to one embodiment, the routing/hub device may be managed by a communications service provider (e.g. a cellular network provider), which can manage the APIs, long range communications, and data analysis and reporting. The data analysis and reporting portion may also be performed by a third party service with the communications being facilitated by the communications service provider.

While the example systems, communication modes, interface mechanisms are described with exemplary features, embodiments may be implemented with any of those protocols and features, as well as additional ones, using the principles described herein.

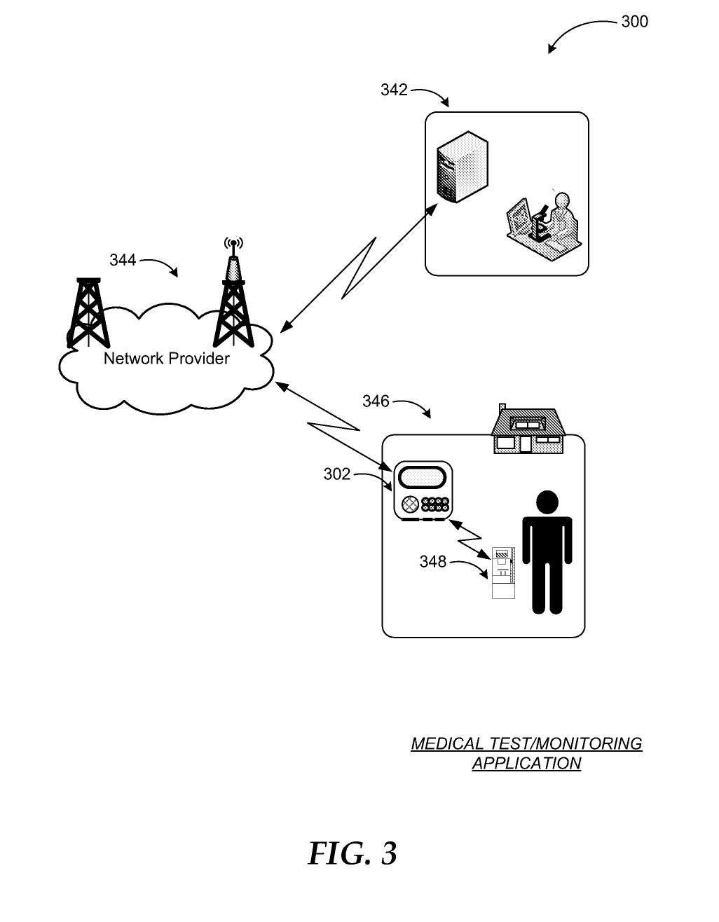

FIG. 3 is a conceptual diagram illustrating an example routing/hub device communicating with data reporting and analysis repository in a medical test and monitoring application according to embodiments.

A common usage scenario for a number of embodiments is envisioned in the medical services area. As discussed previously, healthcare test and monitoring is currently in a less than efficient and desirable state. While personal test and monitoring devices are available, many are not configured to interface with larger data management systems in an efficient manner. Healthcare facility based systems are typically cumbersome, costly, and impractical for home use.

Thus, a system according to embodiments may utilize a routing/hub device 302 to manage one or more test and monitoring devices 348 at a patient's home 346 (e.g. a blood pressure monitor, a diabetes testing machine, etc.). The test and monitoring devices may be configured through the routing/hub device 302 to collect data periodically or otherwise. Depending on end device capability and configuration, end devices 348 may communicate with the routing/hub device 302 wirelessly or through a wired communication. The communication between the routing/hub device 302 and the end devices does not need to be continuous. In some cases, the user may plug in the end device to the routing/hub device and download collected data at that time.

Routing/hub device 302 in turn communicates through a communication network 344 managed by a network provider with a data management system 342. Data management system 342 may be established at a healthcare provider's facility, managed by a third party or even by the network provider. Data from routing/hub device 302 may be processed, analyzed, and stored by the data management system 342. Actions such as providing reports to healthcare providers, alerting emergency service providers, messages to pharmacies, family members, and so on may be performed by the data management system 342 based on predefined and/or customized rules associated with the collected data.

By using such a modular and customizable system, basic healthcare functionality can be extended beyond the hospitals, offices, and labs into an ever-present wireless environment with Internet connectivity, making healthcare providers more efficient and increasing healthcare system's capacity. Moreover, healthcare consumers can be equipped with the ability to generate and monitor their own medical data as it flows into a secure web portal that they, their advocates, and their chosen care providers may access to collaborate on the best course of action. Furthermore, a pull-through market mechanism can be created that equips healthcare consumers with the tools they need to make better healthcare choices and to communicate more efficiently with their healthcare providers regarding their treatment options.

Routing/hub device 302 may be equipped with a rechargeable battery and onboard fixed and/or removable memory storage. It may connect to one or more commercially available medical testing components, as discussed above, utilizing one or more standard technologies such as photochemical, spectroscopic, electrochemical, or micro-needle, or other miniaturized means of in vitro or in vivo testing of bodily fluids or tissue samples such as lab-on-chip to quantify one or more metabolites in a blood, urine, saliva or interstitial fluid or body tissue sample (i.e. glucose blood testing). Various visual indicators for displaying the operational status the routing/hub device such as ‘testing’, ‘transmitting’ and ‘receiving’, as well as various visual/audible alarms for alerting the healthcare consumer or an associated healthcare provider to test and/or analysis results may be provided through the device. Emergency alert tools such as a 911 Call Button may be used to activate an emergency only cellular/PSTN voice channel for the immediate request of local emergency services.

Routing/hub device 302 may also be equipped with location detection services such as GPS to provide the location of the patient to healthcare/emergency service providers should the patient become incapacitated. Moreover, modules such as an accelerometer with an override/reset feature for monitoring and reporting on the consumer's ambulatory state, as well as other for facilitating improvements in current and future health care management methodologies and practices for chronic, sub-acute and acute health conditions may be implemented.

Medical conditions where the user of a system as described above may be useful include blood pressure/cholesterol/heart rate monitoring, medication intake monitoring, diabetes testing, cancer, obesity, HIV, end-of-life care, and other chronic/sub-acute/acute conditions.

According to an example scenario, a diabetes patient scheduled for surgery may be provided a medication intake monitoring device by their healthcare provider to ensure proper intake of medication pre- and post-operation. The patient may also have a diabetes testing device and a blood pressure monitoring device. A routing/hub device available from the patient's communications services provider may be used to collect data from all three of these devices and provide the data to a data management service operated by a third party. The third party may analyze the data and provide daily reports to the healthcare provider. At the same time, the routing/hub device may be configured to send alert messages to the patient's doctor, one of their family members, and even the local emergency services if a predefined threshold for anyone of the monitored conditions is reached.

While the example devices, systems, and scenarios in FIGS. 1, 2, and 3 have been described with specific components and features, embodiments are not limited to these components or system configurations and can be implemented with other system configuration employing fewer or additional components. Functionality of the systems enabling test and monitoring device management may also be distributed among the components of the systems differently depending on component capabilities and system configurations.

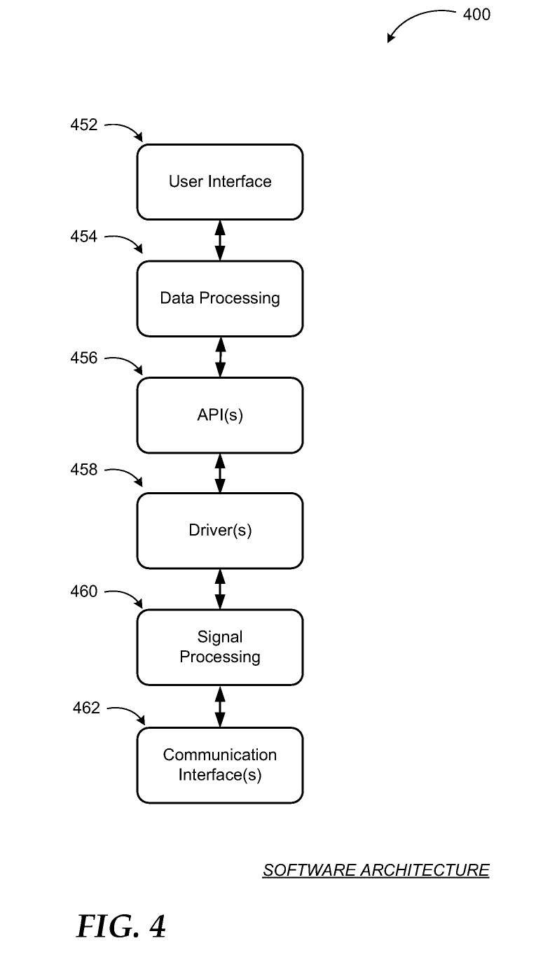

FIG. 4 illustrates example software architecture for a routing/hub device according to embodiments. A routing/hub device as described herein includes one or more user interface elements 452 for configuring the device, managing operation of peripheral devices/communications, and so on. A data processing layer 454 may be used to process inputs from the user interface elements as well as from the peripheral devices and other components of the system such as the remote data management component. As discussed earlier, preconfigured/customized APIs 456 may be stored and utilized in the routing/hub device to interface with multiple peripheral test and monitoring devices. Each device may also have its own drivers 458, which may be uploaded to the routing/hub device by the user, data management system, or other means.

A signal processing component 460 of the routing/hub device may be used to process digital and analog signals received from other devices directly or through network communications. Such signals are received through communication interfaces 462 as exemplified in conjunction with FIGS. 1 and 2.

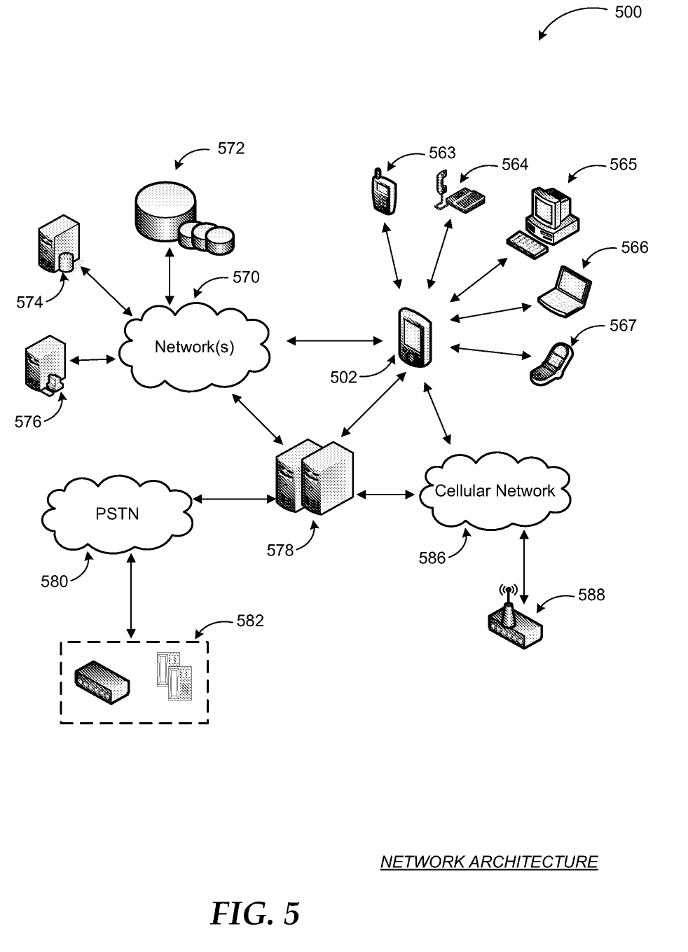

FIG. 5 is an example networked environment, where embodiments may be implemented. Test and monitoring device management as described previously may be implemented locally or in a distributed manner over a number of physical and virtual clients and servers. Such a system may typically involve one or more networks such as networks 570, PSTN 580, cellular network 586. At least one of the systems may be implemented in un-clustered systems or clustered systems employing a number of nodes communicating over one or more networks.

A system according to embodiments may comprise any topology of servers, clients, Internet service providers, and communication media. Also, the system may have a static or dynamic topology. The term “client” may refer to a client application or a client device. A system according to embodiments may involve many more components, typical and relevant ones are discussed in conjunction with this figure.

Routing/hub device 502 manages and collects data from a number of peripheral test and monitoring device (not shown). In response to predefined rules, routing/hub device 502 may provide messages, data, and/or alerts to communication devices such as client devices 563-567 directly or over networks such as PSTN 580 or cellular network 586. Routing/hub device 502 also provides collected data and receives configuration information from a data management service managed by server(s) 578. The data management service may be implemented in a distributed manner over one or more networks 570 and include data storage facilities 572, database servers 574, communication servers 576, etc. The service may analyze the collected data and perform actions such as providing reports, alerts, etc. to recipients through client devices 563-567. If the communication is through PSTN 580, other peripheral communication devices such as a PBX 582 may be involved. If the communication is through cellular network 586, appropriate peripheral devices such as an RF modem 588 may be involved. As mentioned previously, a unified communication system with one or more specialized or combination servers (not shown) for presence, routing, and other functionalities, may also be utilized.

Communication between any nodes described in the diagram 500 may include wired media such as a wired network or direct-wired connection, and wireless media such as acoustic, RF, infrared and other wireless media.

Many other configurations of computing devices, applications, data sources, data distribution systems may be employed to implement test and monitoring device management. Furthermore, the networked environments discussed in FIG. 5 are for illustration purposes only. Embodiments are not limited to the example applications, modules, or processes.

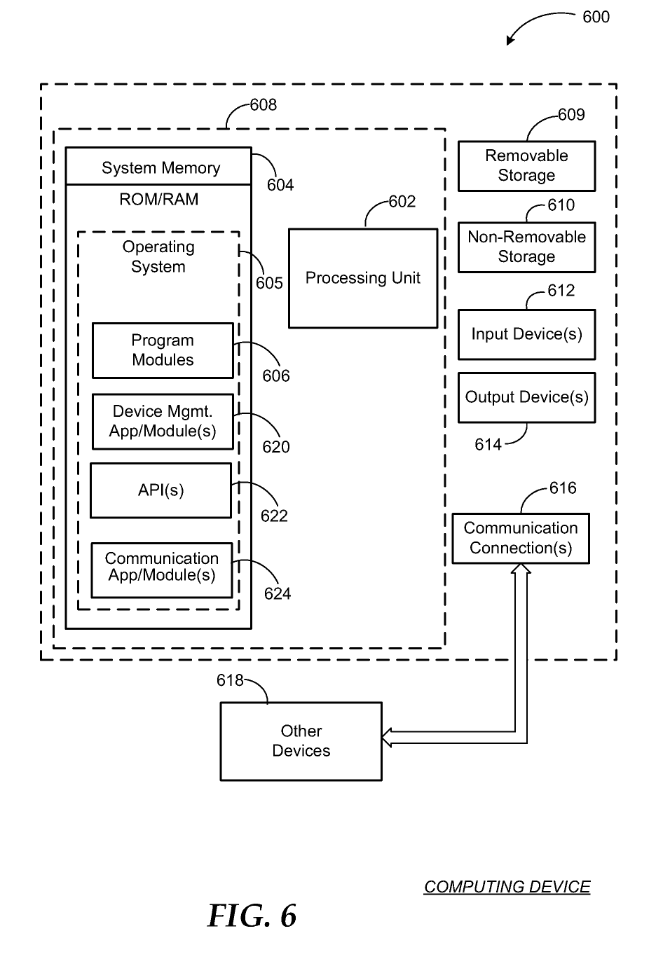

FIG. 6 and the associated discussion are intended to provide a brief, general description of a suitable computing environment in which embodiments may be implemented. With reference to FIG. 6, a block diagram of an example computing operating environment is illustrated, such as computing device 600. In a basic configuration, the computing device 600 may be a any computing device capable of performing the functionality of a routing/hub device as discussed above. Computing device 600 may typically include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the computing device, such as the WINDOWS® operating systems from MICROSOFT CORPORATION of Redmond, Wash. The system memory 604 may also include one or more software applications such as program modules 606, device management application (or modules) 620, API(s) 622, and communication applications/modules 624.

Device management application/modules 620 manages any connected test and monitoring devices through preconfigured rules or inputs from local or remote input systems. In managing the test and monitoring devices, device management application 620 may utilize one or more APIs 622 to interface with the individual devices. Communication applications/modules 624 may be separate applications or integral modules of the computing device to provide advanced communication services with peripheral and remote devices and systems. This basic configuration is illustrated in FIG. 6 by those components within dashed line 608.

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well known in the art and need not be discussed at length here.

The computing device 600 may also contain communication connections 616 that allow the device to communicate with other devices 618, such as over a wireless network in a distributed computing environment, for example, an intranet or the Internet. Other devices 618 may include client devices and servers of a data management system network, communication devices designated to receive alerts/messages, and the like, as discussed above. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The claimed subject matter may also be implemented as methods. These methods can be implemented in any number of ways, including the structures described in this document. One such way is by machine operations, of devices of the type described in this document. Another optional way is for one or more of the individual operations of the methods to be performed in conjunction with one or more human operators performing some. These human operators need not be collocated with each other, but each can be only with a machine that performs a portion of the program.

Any operations performed by the routing/hub device or other components of a system according to embodiments for managing test and monitoring devices may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A portable computing device for managing test and monitoring end devices, the computing device comprising:
a memory;
a processor coupled to the memory, the processor configured to perform actions including:
receive data from at least one test and monitoring end device;
perform a preliminary analysis on the received data;
if a predefined criterion is met, notify a communication end device;
transmit the received data to a data repository and analysis system; and
manage at least one Application Programming Interface (API) for communication with the at least one test and monitoring end device; and
a communication module configured to communicate through a plurality of communication modes with the at least one test and monitoring end device, the at least one communication end device, and the data repository and analysis system.

2. The computing device of claim 1, further comprising:
a user interface component arranged to enable a user to configure at least one from a set of: test and monitoring parameters and communication parameters associated with the computing device.

3. The computing device of claim 1, wherein the at least one test and monitoring end device is a medical condition monitoring device.

4. The computing device of claim 1, wherein the communication module is further configured to communicate with the at least one test and monitoring end device through one of a radio frequency wireless means, a wired communication means, and an optical communication means.

5. The computing device of claim 1, wherein the communication module is further configured to communicate with the at least one communication end device and the data repository and analysis system through at least one from a set of: a wireless public network, a wireless private network, a wired public network, and a wired private network.

6. The computing device of claim 1, wherein the communication to the at least one communication end device includes one of: an audio alert, a video alert, a text message, a voice message, and a data upload.

7. The computing device of claim 1, wherein the processor is further configured to provide one of a visual and an audio alert to a user in response to detecting that a predefined condition associated with the received data is met.

8. The computing device of claim 1, wherein the data repository and analysis system is configured to analyze the received data and provide a report to a designated third party through one of a wired and wireless network.

9. The computing device of claim 8, wherein the data repository and analysis system is further configured to provide configuration information to the computing device associated with at least one of the computing device and one of the test and monitoring devices in response to analyzing the received data.

10. The computing device of claim 1, wherein the processor is further configured to provide instructions to a peripheral device capable of administering one of: a medication and a non-chemical therapeutic action in response to receiving configuration information from the data repository and analysis system.

11. The computing device of claim 1, wherein the computing device is implemented as an integral part of one of: a handheld computer, a smart phone, a smart console, a Personal Digital Assistant, and a desktop computing device.

12. A system for managing test and monitoring devices, the system comprising:
a routing/hub device configured to:
receive data from at least one test and monitoring end device;
perform a preliminary analysis on the received data;
if a predefined criterion is met, notify a communication end device;
transmit the received data to a data repository and analysis system; and
manage at least one API for communication with the at least one test and monitoring end device; and
enable a user to configure at least one from a set of: test and monitoring parameters and communication parameters associated with the routing/hub device;
the data repository and analysis system configured to:
analyze the received data from the routing/hub device;
provide a report to a designated third party based on the analyzed data;
provide configuration information to the computing device associated with at least one of the routing/hub device and one of the test and monitoring devices in response to analyzing the received data;
store at least a portion of the analyzed data; and
a plurality of test and monitoring devices coupled to the routing/hub device through at least one of wireless means and wired means.

13. The system of claim 12, wherein the routing/hub device is further configured to:
enable an authorized third party to communicate at least one from a set of: test and monitoring parameters and communication parameters associated with the routing/hub device through one of a public communication network and a private communication network.

14. The system of claim 12, wherein the routing/hub device is configured to set authorization parameters for the transmitted data such that access to the data is restricted according to predefined permission rules.

15. The system of claim 12, wherein the data repository and analysis system is further configured to:
provide the report to the designated third party based on one of: third party defined transmission rules and predefined transmission rules; and
allow access to at least a portion of the report based on user defined permission rules.

16. The system of claim 12, wherein routing/hub device further includes a location detection capability for locating a user in response to one of: a request from the designated third party and a predefined condition based on the analyzed data.

17. The system of claim 12, wherein the data repository and analysis system is further configured to perform at least one of data mining on stored data and trending analysis on received data from a plurality of routing/hub devices.

18. A medical test and monitoring management device capable of executing computer-readable instructions stored on a computer-readable storage medium for managing a plurality of test and monitoring devices, the instructions comprising:
receiving configuration information from at least one of a data repository and analysis system and a user;
managing at least one API for communication with the plurality of test and monitoring devices;
configuring the plurality of test and monitoring devices based on the received configuration information;
receiving data from the test and monitoring devices;
performing a preliminary analysis on the received data;
if a predefined criterion is met, notifying a designated third party through communication over at least one of a public and a private communication network;
transmitting the received data to the data repository and analysis system over at least one of a public and a private communication network based on the received configuration information; and
enabling a therapeutic administration device to administer one of a chemical therapeutic treatment and a non-chemical therapeutic treatment in response to instructions from one of the data repository and analysis system and the designated third party.

19. The medical test and monitoring management device of claim 18, wherein the instructions further comprise:
implementing a profile based authorization scheme to restrict access to collected data and administration of therapeutic therapy.

20. The medical test and monitoring management device of claim 18, wherein the instructions further comprise:
utilizing preconfigured and customizable templates for common health conditions in configuring test and monitoring devices and providing reports based on collected data.
